(19) United States
(12) Patent Application Publication
(10) Pub. No.: US 2019/0068804 A1
(43) Pub. Date: Feb. 28, 2019

(54) INFORMATION TRANSMISSION APPARATUS, INFORMATION TRANSMISSION SYSTEM, MULTIFUNCTION PERIPHERAL, INFORMATION TRANSMISSION METHOD, AND INFORMATION TRANSMISSION PROGRAM

(71) Applicant: SHARP KABUSHIKI KAISHA, Sakai City (JP)

(72) Inventors: MASASHI ICHIKAWA, Sakai City (JP); YUICHI NISHII, Sakai City (JP); MIYOKO MARUYAMA, Sakai City (JP)

(21) Appl. No.: 16/111,640

(22) Filed: Aug. 24, 2018

(30) Foreign Application Priority Data
Aug. 28, 2017 (JP) 2017-162940
Jul. 5, 2018 (JP) 2018-128275

(51) Int. Cl. H04N 1/00; G06F 21/31

(52) U.S. Cl. CPC H04N 1/00209; G06F 21/31; H04N 2201/3208; H04N 2201/3278; H04N 2201/0094

(57) ABSTRACT

An information transmission system includes a unit configured to cause an authentication unit to perform authentication based on authentication information, a unit configured to cause a search unit to search for at least one transmission destination associated with the authentication information by using a text string corresponding to the authentication information as a keyword, and an information transmission unit configured to transmit information using a result of the search performed by the search unit. The authentication unit and the search unit are disposed in an external apparatus connected to the information transmission apparatus via a network.

### BACKGROUND

### 1. Field

The present disclosure relates to an information transmission apparatus, an information transmission system, a multifunction peripheral, an information transmission method, and an information transmission program, for selecting a transmission destination associated with an authenticated user.

### 2. Description of the Related Art

As a method of authentication performed by a multifunction peripheral, it is widely known to check whether an input user ID and an input password are respectively identical to a user ID and a password registered in advance. When a user successfully passes authentication, the user is allowed to use the multifunction peripheral to execute various kinds of jobs such as copying, printing, facsimile transmission, receiving information via facsimile, reading a document using a scanner function, etc.

Of these various jobs, for example, in a job of reading a document using the scanner function, data obtained as a result of reading the document is usually transmitted. to a personal computer or the like via a network. To achieve the transmission, an email address is used.

Japanese Unexamined Patent Application Publication No. 2006-101484 (laid open on Apr. 13, 2006), discloses a technique in which after a user successfully passes authentication, when the user selects a transmission destination from transmission destinations registered in an address book stored in a multifunction peripheral, transmission to the selected transmission destination is performed.

It is also disclosed that it is allowed for the authenticated user to transmit data obtained as a result of reading to a personal computer of the user at a specified email address associated with authentication information via a mail server.

### SUMMARY

In recent years, it has become popular for a single user to nave a plurality of email addresses used for different purposes. For example, a certain email address is for use in normal situations, another email address is for use in emergency situations, and a still another email address is shared by family members.

In the technique disclosed in Japanese Unexamined Patent Application Publication No. 2006-101484, the number of email addresses allowed as the transmission destination to the user is limited to only one, that is, this technique does not, allow the user to have a plurality of email addresses to be used for different purposes.

To handle the above situation, a user may register a plurality of email addresses of the user in an address book, and user may select one from the plurality of email addresses depending on the purpose. However, in a case where the address book includes many other addresses in addition to the email addresses of the user, the user is supposed to look for a specific address to be used, or the user is supposed to perform a search by inputting characters or numerals of all or part of the address, and thus the user may have to do a troublesome and inefficient job.

To handle the above situation, as many pieces of user information for authentication may be registered as the number of email addresses the user wants to use. However, in this case, the user may have to perform an operation for authentication using a login name and a password corresponding to each email address to be used. Therefore, the user is supposed to remember all login names, passwords, and associated email addresses.

In view of the above, the present disclosure provides an information transmission apparatus, an information transmission system, a multifunction peripheral, an information transmission method, and an information transmission program, capable of allowing a user to easily specify a desired transmission destination by making a selection from a plurality of transmission destinations associated with an authenticated user himself/herself or transmission destinations related to the user.

According to an aspect of the disclosure, there is provided an information transmission apparatus including a unit configured to cause an authentication unit to perform authentication based on authentication information, a unit configured to cause a search unit to search for at least one transmission destination associated with the authentication information by using a text string corresponding to the authentication information as a keyword, and an information transmission unit configured to transmit information using a result of the search performed by the search unit, wherein the authentication unit and the search unit are disposed in an external apparatus connected to the information transmission apparatus via a network.

According to an aspect of the disclosure, there is provided an information transmission system including an authentication unit configured to perform authentication based on authentication information, a search unit configured to search for at least one transmission destination associated with the authentication information by using a text string corresponding to the authentication information as a keyword, and an information transmission unit configured to transmit information using a result of the search performed by the search unit, wherein the authentication unit and the search unit are disposed in an external apparatus connected to an apparatus including the information transmission unit via a network.

According to an aspect of the disclosure, there is provided an information transmission system including performing authentication based on authentication information, searching for at least one transmission destination associated with the authentication information by using a text string corresponding to the authentication information as a keyword, and transmitting information using a result of the search performed in the searching, wherein the authentication and the search are performed in an external apparatus connected via a network to an apparatus that performs the transmission of the information.

### BRIEF DESCRIPTION OF THE DRAWINGS

FIG. 1 is a functional bock diagram illustrating functional configurations of a multifunction peripheral and an external authentication server according to a first embodiment of the disclosure;

FIG. 2 is a conceptual cross-sectional view illustrating a configuration of the multifunction peripheral according to the first embodiment of the disclosure;

FIG. 3 is a flow chart illustrating an operation of the multifunction peripheral performed after authentication is passed, according to the first embodiment of the disclosure;

FIG. 4 is a flow chart illustrating operations of the multifunction peripheral and the external authentication server according to the first embodiment of the disclosure;

FIG. 5A is a diagram illustrating an example of a login screen displayed on a display unit of a multifunction peripheral according to the first embodiment of the disclosure;

FIG. 5B is a diagram illustrating an example of a user list according to the first embodiment of the disclosure;

FIG. 5C is a diagram illustrating an example of a user list of keywords according to the first embodiment of the disclosure;

FIG. 6 is a diagram illustrating a processing flow of operations of a multifunction peripheral and an external authentication server according to the first embodiment of the disclosure;

FIGS. 7A, 7B, and 7C are diagrams respectively illustrating a scanner screen, an address book screen, and a home screen, each including a my address search button, displayed on a display unit of a multifunction peripheral according to the first embodiment of the disclosure;

FIG. 8A is a diagram illustrating a screen for use in an address search according to the first embodiment of the disclosure;

FIG. 8B is a diagram illustrating a screen for use in direct inputting according to the first embodiment of the disclosure;

FIG. 8C is a diagram illustrating a screen for use in a my address search according to the first embodiment of the disclosure;

FIG. 9 is a diagram illustrating a manner in which an email address is specified on a display unit of a multifunction peripheral according to the first embodiment of the disclosure;

FIG. 10 is a diagram illustrating a processing flow of operations of a multifunction peripheral and an LDAP/AD server according to the first embodiment of the disclosure;

FIGS. 11A and 11B are diagrams each illustrating an example of a user list according to a fourth embodiment of the disclosure; and

FIG. 12 is a functional block diagram illustrating an example of a functional configuration of a my address search apparatus and related apparatuses according to a seventeenth embodiment of the disclosure.

### DESCRIPTION OF THE EMBODIMENTS

Referring to drawings, embodiments of the present disclosure are described in detail below.

### First Embodiment

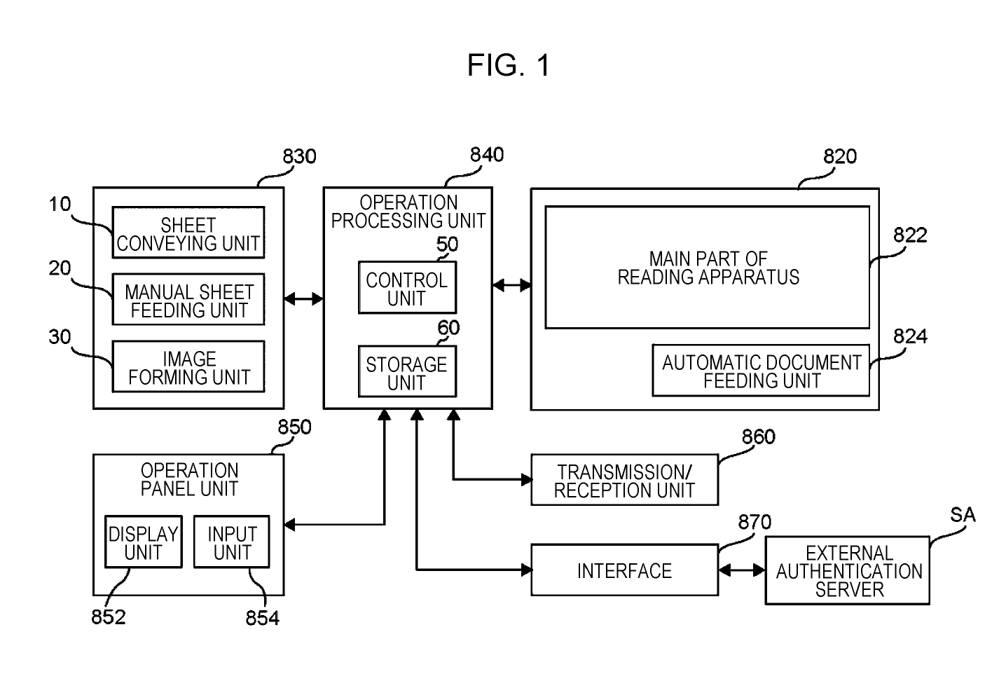

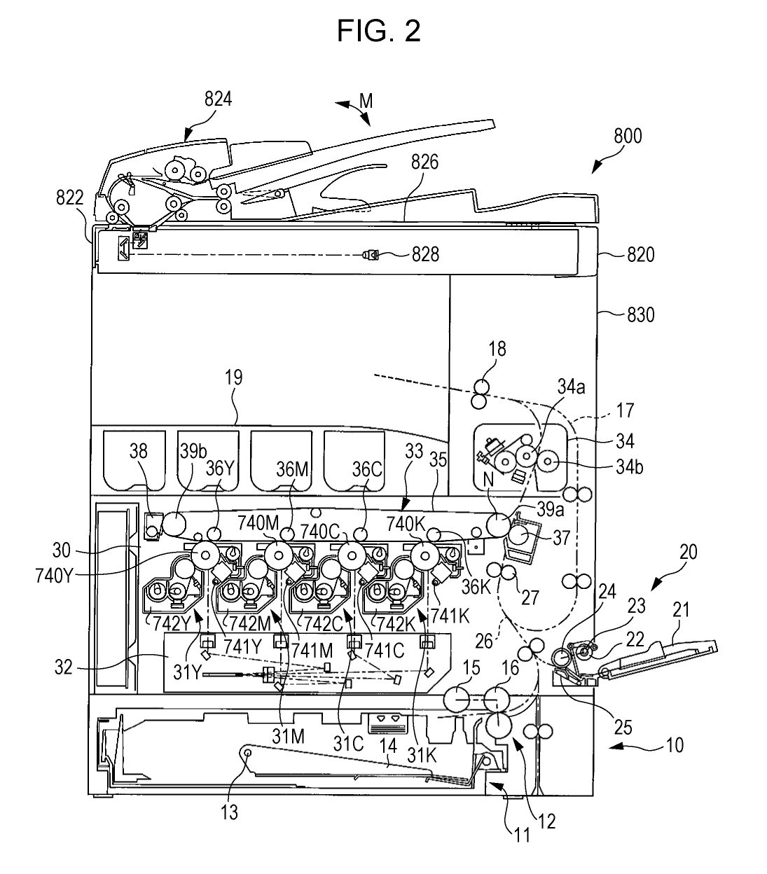

A first embodiment described below relates to a multifunction peripheral 800 including an information transmission apparatus described below in second to nineteenth embodiments. FIGS. 1 and 2 illustrate an example of a configuration of the multifunction peripheral 800.

As illustrated in FIG. 1 and FIG. 2, the multifunction peripheral 800 includes a document reading apparatus 820 configured to read an image of a document, a main part 830 of the multifunction peripheral (a main part of an image forming unit) configured to form an image on a sheet, an operation panel unit 850 for operating the document reading apparatus 820 and the main part 830 of the multifunction peripheral, an operation processing unit 840 configured to control the document reading apparatus 820 and the main part 830 of the multifunction peripheral based on the operation performed on the operation panel unit 850, a transmission/reception unit 860 configured to transmit/receive image information via various public communication lines, and an interface 870 for realizing a wired or wireless connection with an external authentication server SA.

The operation panel unit 850 is a touch panel display including a display unit 852 and an input unit 854. Various kinds of information and buttons are displayed on the operation panel unit 850 depending on a mode of the multifunction peripheral 800.

The transmission/reception unit 860 is capable of transmitting an image read by the document reading apparatus 820 and an image stored in a storage apparatus, and also capable of receiving an image from the outside.

The document reading apparatus 820 includes an automatic document feeding unit (SPF (Single Pass Feeder)) 824 configured to automatically feed a document, and a main part 822 of reading apparatus configured to read an image of the document. Note that the document reading apparatus 820 includes, in addition to constituent elements shown in FIG. 2, other constituent elements not shown in FIG. 2 but shown in FIG. 1. Furthermore, as shown in FIGS. 1 and 2, the main part of reading apparatus 822 includes a document table 826.

The main part 830 of the multifunction peripheral includes a sheet feeding unit 10 configured to feed a sheet, a manual sheet feeding unit 20 capable of manually feeding a sheet, and an image forming unit 30 configured to form an image on the sheet fed by the sheet feeding unit 10 or the manual sheet feeding unit 20.

The sheet feeding unit 10 includes a sheet stacking unit 11 configured to place a stack of sheets, and a separate-and-feed unit 12 configured to pick up one sheet at a time from the stack of sheets placed on the sheet stacking unit 11 and feed the picked-up sheet. The sheet stacking unit 11 includes an intermediate plate 14 capable of turning about a rotation shaft 13. When a sheet is fed, the intermediate plate 14 is turned so as to lift up sheets. The separate-and-feed unit 12 includes a pickup roller 15 configured to feed the sheets lifted up by the intermediate plate 14, and a separation roller pair 16 configured to separate the sheets fed by the pickup roller 15 and feed out one sheet at a time.

The manual sheet feeding unit 20 includes a manual feed tray 21 on which a stack of sheets is allowed to be put, and a separate-and-feed unit 22 configured to separate sheets placed on the manual feed tray 21 and feed out one sheet at time. The manual feed tray 21 is rotatably supported by the main part 830 of the multifunction peripheral. When sheets are manually fed, the manual feed tray 21 is fixed at a particular angle such that a stack of sheets is allowed to be put on the manual feed tray 21. The separate-and-feed unit 22 includes a pickup roller 23 configured to feed sheets from the stack of sheets placed on the manual feed tray 21, and a separation roller 24 and a separation pad 25 configured to cooperate to separate the sheets fed by the pickup roller 23 and feed out one sheet at a time.

The image forming unit 30 includes four process cartridges 31Y to 31K for forming images of yellow (Y), magenta (M), cyan (C), and black (K), photosensitive drums 740Y to 740K that will be described later, an exposure apparatus 32 configured to expose surfaces of the photosensitive drums 740Y to 740K, a transfer unit 33 configured to transfer toner images formed on the surfaces of the respective photosensitive drums 740Y to 740K to the sheet, and a fixing unit 34 configured to fix the transferred toner image on the sheet. Note that an alphabetic suffix (Y, M, C, K) following a reference numeral indicates a color (yellow, magenta, cyan, black).

Each of the four process cartridges 31Y to 31K is removable from the main part 830 of the multifunction peripheral and is exchangeable. The four process cartridges 31Y to 31K are similar in structure except that they form images of different colors, and thus the process cartridge 31Y for forming a yellow (Y) image is taken as an example in the following description of the structure of process cartridges, and a description of the other process cartridges 31M to 31K is omitted.

The process cartridge 31Y includes the photosensitive drum 740Y functioning as an image carrier, a charger 741Y configured to electrically charge the photosensitive drum 740Y, a development apparatus 742Y configured to develop an electrostatic latent image formed on the photosensitive drum 740Y, and a drum cleaner configured to remove toner remaining on the surface of the photosensitive drum 740Y. The development apparatus 742Y includes a main part (whose details are not shown in the figure) of the development apparatus that develops the photosensitive drum 740Y, and a toner cartridge (whose details are not shown in the figure) that supplies toner to the main part of the development apparatus. The toner cartridge is removable from the main part of the development apparatus. When the toner in the toner cartridge is completely consumed, the toner cartridge is allowed to be removed from the main part of the development apparatus and exchanged.

The exposure apparatus 32 includes a light source (not shown in the figure) that emits a laser beam, and a plurality of mirrors (not shown in the figure) that direct the laser beam to the photosensitive drums 740Y to 740K. The transfer unit 33 includes an intermediate transfer belt 35 configured to carry the toner images formed on the photosensitive drums 740Y to 740K, primary transfer rollers 36Y to 36K configured to primarily transfer the toner images formed on the photosensitive drums 740Y to 740K to the intermediate transfer belt 35, a secondary transfer roller 37 configured to secondarily transfer the toner image from the intermediate transfer belt 35 to the sheet, and a belt cleaner 38 configured to remove toner remaining on the intermediate transfer belt 35. The intermediate transfer belt 35 is stretched between a driving roller 39a and a driven roller 39b, and the intermediate transfer belt 35 is urged by the primary transfer rollers 36Y to 36K against the photosensitive drums 740Y to 740K. The intermediate transfer belt 35 is nipped between the secondary transfer roller 37 and the driving roller 39a such that the toner image carried by the intermediate transfer belt 35 is transferred, at a nip part N, to the sheet. The fixing unit 34 includes a heating roller 34a configured to heat the sheet, and a pressure roller 34b configured to press the sheet against the heating roller 34a.

The operation panel unit 850 includes a display unit 852 configured to display information, and an input unit 854 for use by a user in inputting an instruction to the document reading apparatus 820 and the main part 830 of the multifunction peripheral. In the present embodiment, the operation panel unit 850 is disposed on a front side of the main part 822 of the reading apparatus. Note that the front side corresponds to a front side of the page of FIG. 2, and the back side corresponds to a back side of the page.

As shown in FIGS. 1 and 2, the operation processing unit 840 includes a control unit 50 and a storage unit 60. The control unit 50 is configured to control driving of the sheet feeding unit 10, the manual sheet feeding unit 20, and the image forming unit 30 and the document reading apparatus 820. The storage unit 60 stores various programs according to which the control unit 50 operates and also stores various kinds of information used by the control unit 50. The storage unit 60 is capable of storing an image read by the document reading apparatus 820 or received by the transmission/reception unit 860. The operation processing unit 840 integrally controls operations of the sheet feeding unit 10, the manual sheet feeding unit 20, the image forming unit 30, and the document reading apparatus 820 in accordance with an operation performed by a user on the operation panel unit 850 so as to form an image on a sheet.

Next, an image forming operation performed by the multifunction peripheral 800 configured in the above-described manner (that is, an image formation control operation by the operation processing unit 840) is described below. In the following description of the image forming operation according to the present embodiment, it is assumed by way of example that a document is fed by the automatic document feeding unit 824, an image of the document is read by the main part 822 of the reading apparatus, and the image of he document is formed, by the image forming unit 30, on a sheet fed by the sheet feeding unit 10.

When a user operates the input unit 854 of the operation panel unit 850 and, as a result, an image formation start signal is issued, documents placed by the user on the automatic document feeding unit 824 are automatically fed to a document reading position, and an image of the document is read, at this document reading position, by the main part 822 of the reading apparatus.

After the image of the document is read by the main part 822 of the reading apparatus, the exposure apparatus 32 illuminates the photosensitive drums 740Y to 740K with corresponding laser beams according to the image information of the read document. Before this illumination process, the photosensitive drums 740Y to 740K are electrically charged in advance by the chargers 741Y to 741K, and thus the illumination of the respective laser beams causes electrostatic latent images to be formed on the photosensitive drums 740Y to 740K. Thereafter, the electrostatic latent images formed on the photosensitive drums 740Y to 740K are developed by the respective development apparatuses 742Y to 742K. As a result, toner images of yellow (Y), magenta (M), cyan (C), and black (K) are formed on the respective photosensitive drums 740Y to 740K. The toner images of the respective colors formed on the photosensitive drums 740Y to 740K are transferred to the intermediate transfer belt 35 by the primary transfer rollers 36Y to 36K such that the toner images are superimposed on the intermediate transfer belt 35 and thus a full color toner image is formed on the intermediate transfer belt 35. The superimposed toner image is carried by the intermediate transfer belt 35 to the nip part N.

In parallel to the image forming operation described above, the separate-and-feed unit 12 picks up one sheet at a time from the sheets put in the form of a stack on the sheet stacking unit 11, and the pickup roller 15 feeds the sheet to a sheet conveying path 26. A registration roller pair 27 is disposed upstream from the nip part N in the sheet conveying direction such that the registration roller pair 27 corrects skewing of the sheet and conveys the sheet to the nip part N at a predetermined conveying timing. At the nip part N, the full color toner image carried by the intermediate transfer belt 35 is transferred to the sheet by the secondary transfer roller 37.

The toner image transferred to the sheet is fused by heat and pressure in the fixing unit 34, and the sheet is discharged by a discharge roller pair 18 to the outside of the apparatus. After being discharged to the outside of the apparatus, the sheet is put in the form of a stack on the discharged sheet tray 19.

In a case where images are formed on both sides (first and second sides) of a sheet, after an image is formed on the first side of the sheet, the sheet is not discharged to the outside of the apparatus but is conveyed to a duplex path 17 by reversely rotating the discharge roller pair 18 and reconveyed to the image forming unit 30 via the duplex path 17. After an image is formed on the second side in a similar manner to the first side, the sheet is discharged to the outside of the apparatus. After being discharged to the outside of the apparatus, the sheet is put in the form of a stack on the discharged sheet tray 19.

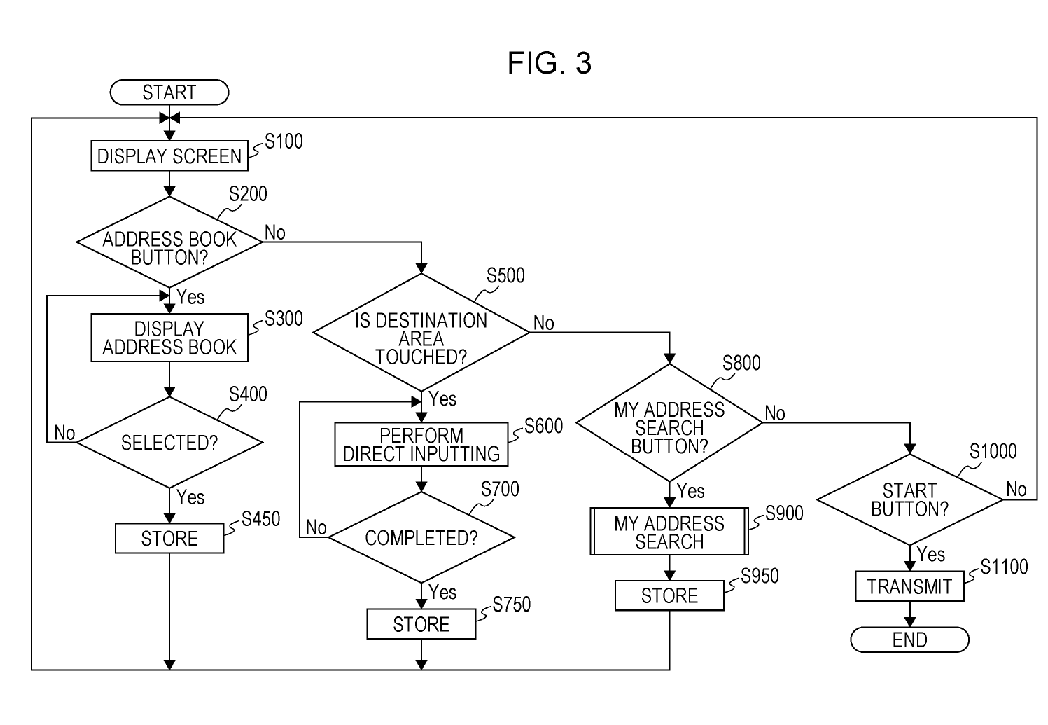

Next, referring to FIG. 3, an operation of the multifunction peripheral according to the first embodiment is described below.

A user may select a desired job from a menu displayed on the display unit 852 of the operation panel unit 850 of the multifunction peripheral 800 thereby causing the multifunction peripheral 800 to execute the selected job. To use the authentication function, authentication registration is performed in advance. In the authentication registration, a user inputs a login name, a password, a user name, and an email address.

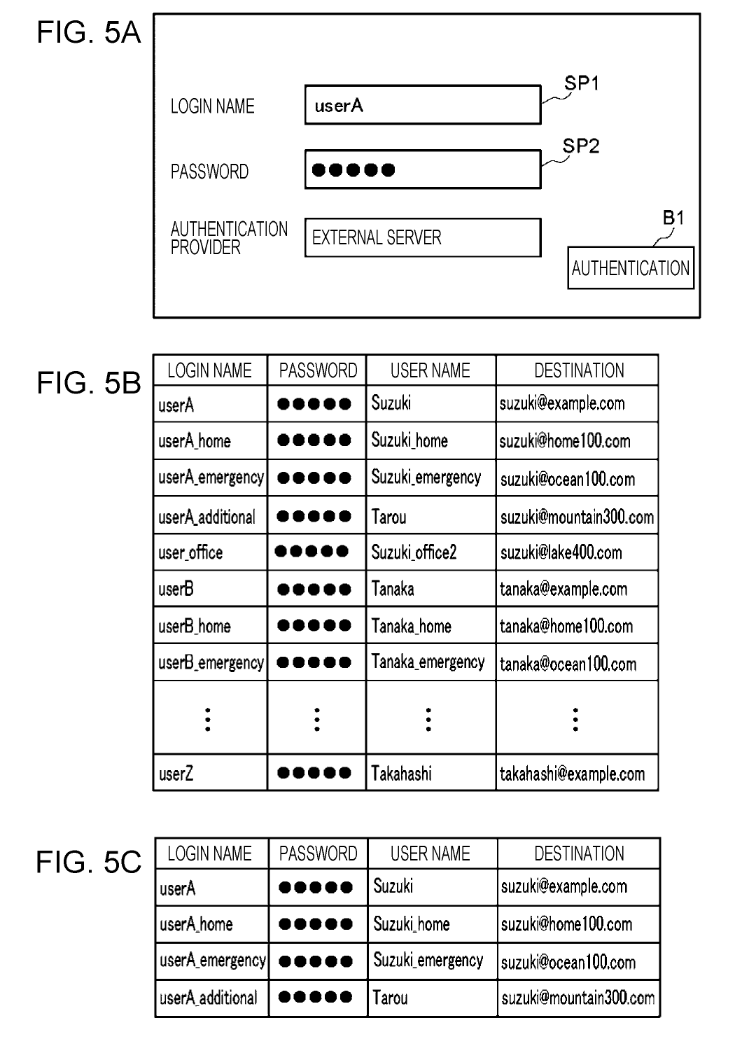

The authentication is performed via an authentication screen such as that shown in FIG. 5A. On the authentication screen, the user inputs his/her login name in a textbox SP1 using the input unit 854, further inputs his/her password in a textbox SP2, and then presses an authentication button B1. In this example, as shown in FIG. 5A, an external server is specified as an authentication service provider.

In response to an authentication request from the multifunction peripheral 800, the external authentication server SA searches for the login name which is “userA” in this specific example, from a user list table whose content is shown by way of example in FIG. 5B. The user list table, which is the search target, exists in the external authentication server SA. In a case where the user list table shown in FIG. 5B is specified as the search target, the external authentication server SA returns to the multifunction peripheral 800 a search result indicating all detected login names each including as a part the input login name “userA”, that is, “userA”, “userA_home”, “userA_emergency”, and “userA_additional” and corresponding user names and email addresses specified as destination addresses. At the multifunction peripheral 800, the user is allowed to select one or more email addresses as destination addresses from the search result. The user list table shown in FIG. 5B includes records each including a login name and items associated with the login name, that is, a password, a user name, and a transmission destination (email address).

Next, referring to the flow chart shown in FIG. 3, the operation of the multifunction peripheral 800 performed after the authentication by the external authentication server SA is ended is described below.

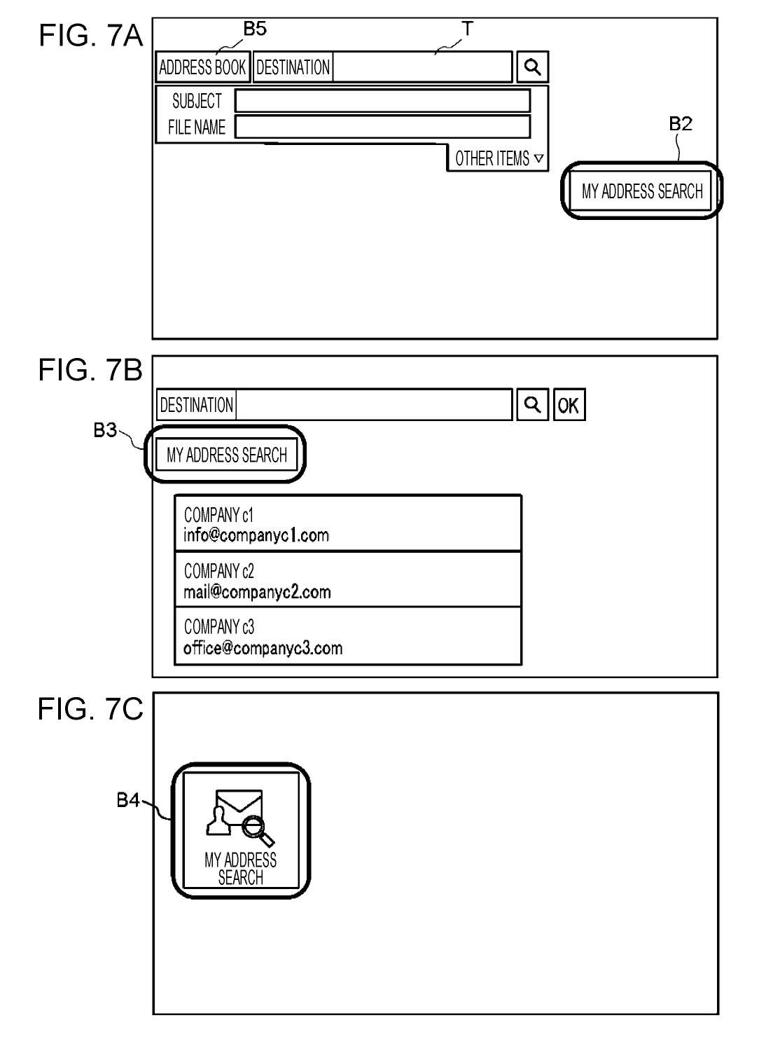

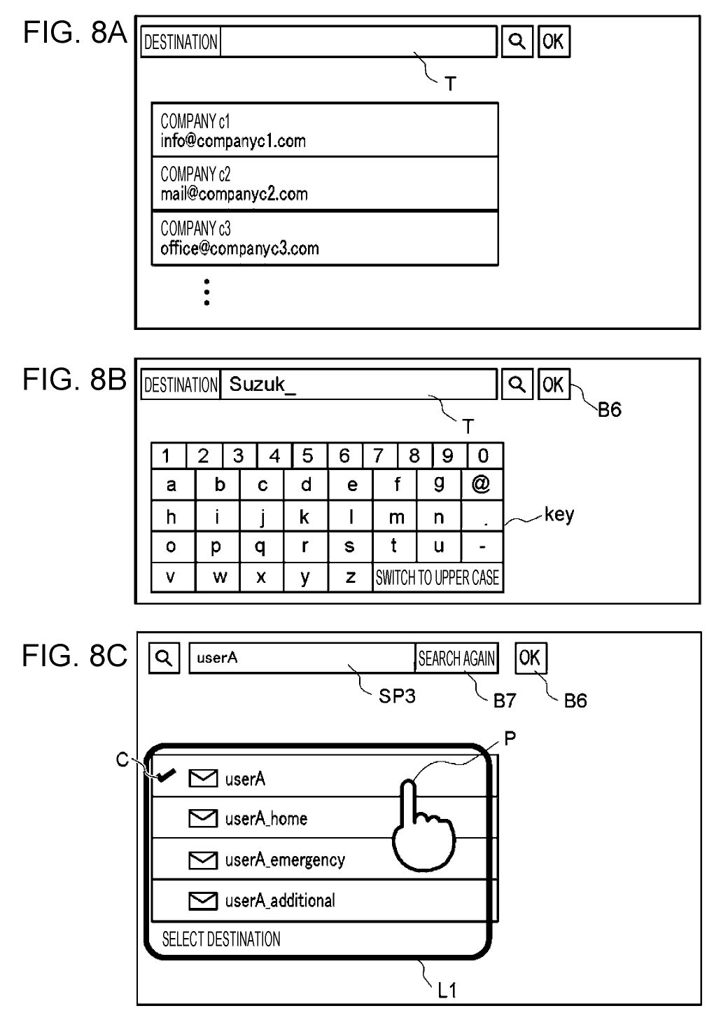

Next, a determination is performed as to whether an address book button B5 shown in FIG. 7A is pressed (step S200). In a case where it is determined that the address book button 135 is pressed, an address book screen shown by way of example in FIG. 8A is displayed (step S300).

FIG. 8A illustrates an example of a user address hook for a user having a user name “use-A”. The user is allowed to select a transmission destination from this address book. For example, “company c1, info@companyc1.com” may be selected as the transmission destination.

Next, a determination is performed as to whether a transmission destination is selected from the address book (step S400). In a case where it is determined that a transmission destination is selected, this address is stored (step S450), and the screen shown in FIG. 8A is displayed again (step S100). Note that on the address book screen, a plurality of selections are allowed. When an OK button is pressed, the original screen is displayed again.

A determination is performed as to whether a destination area T is pressed (step S500). In a case where it is determined that the destination area T is pressed, a screen such as that illustrated in FIG. 8B is displayed such that a user is allowed to directly input a destination address using a keypad (S600). Next, to determine whether inputting of the destination is completed, a determination is performed as to whether an “OK” button B6 is pressed (step S700). In a case where it is determined that inputting is completed, the input destination address is stored (step S750), and the screen shown in FIG. 8A is displayed again (step S100).

A determination is performed as to whether a my address search button B2 is pressed (step S800). When it is determined that the my address search button B2 is pressed, the my address search is performed (step S900). After the my address search is performed, addresses detected in the search are stored (step S950). Note that the my address search is performed by the external authentication server SA according to an instruction issued by a user via the multifunction peripheral 800. Details of the my address search will be described later.

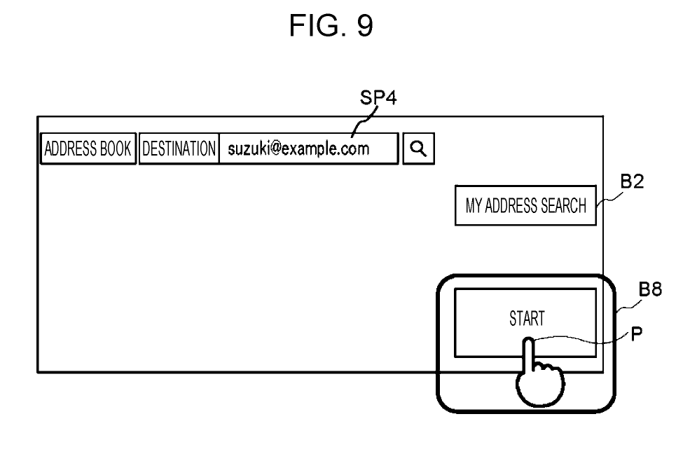

When at least one transmission destination is input, a start button is activated as shown in FIG. 9. A determination is performed as to whether the start button on this screen is pressed (step S1000). In a case where it is determined that the start button is pressed, transmission addressed to all specified destination addresses is performed (step S1100). Thus, specified transmission destinations are cumulatively stored unless the start button is pressed.

Note that the my address search button is not limited to the my address search button B2 provided on the screen shown in FIG. 7A, but a my address search button may be provided on an address book screen such as that shown in FIG. 8A so as to achieve an address book screen such as that shown in FIG. 7B. Furthermore, a my address search button may be provided on a home screen that is displayed first in response to a login operation by a user, as shown in FIG. 7C. By providing the my address search button on the home screen, it becomes possible to directly instruct executing the my address search without through hierarchical other screens.

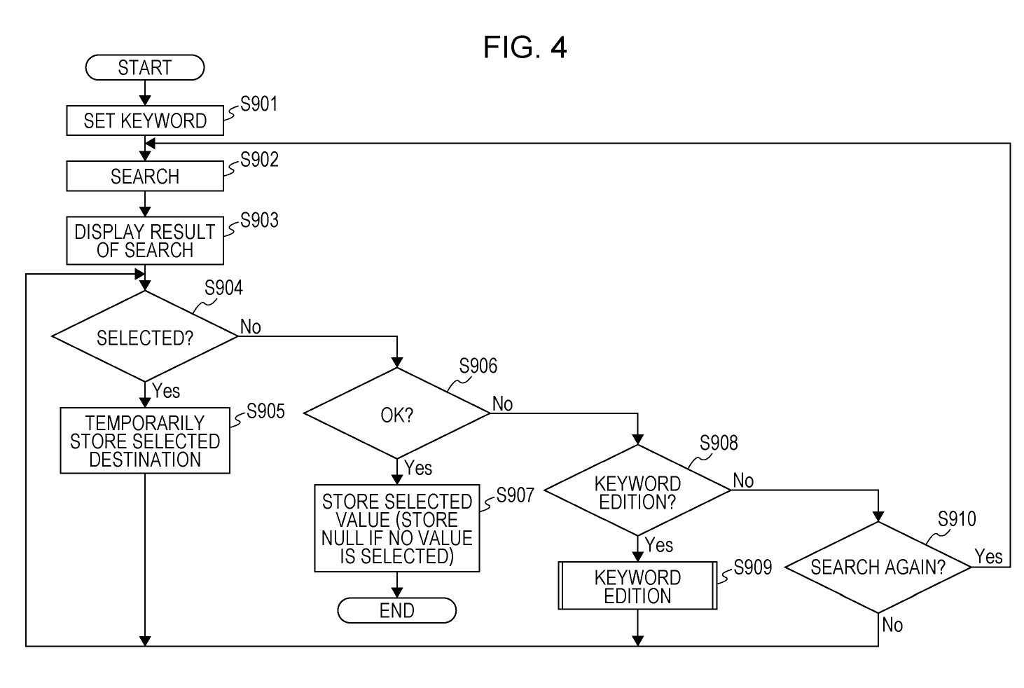

Next, referring to FIG. 4, the my address search (step S900) shown in FIG. 3 is described in further detail.

The “my address search” is a search performed such that a login name of an authenticated user or a user name associated with the login name is employed as a keyword, and the user list table is searched to find email addresses of the user himself/herself or email addresses related to the user, registered in association with login names or user names each including as a part the keyword. Login names detected in the search are displayed as a list on the display unit 852 of the operation panel 850 as shown in FIG. 8C. An email address associated with a login name specified by a user from the displayed list is employed as a transmission destination to which, for example, data output from the scanner is transmitted.

That is, a user who has successfully passed authentication is allowed to use the my address search function to select a desired address from a plurality of registered addresses such as an email address of the user, an email address for emergency, and the like, and transmit data output from the scanner or the like to the selected address. As for the keyword used in the my address search, in addition to the login name, a user name may be used. Furthermore, in the my address search, a text string obtained by editing the login name or the user name may also be used as the keyword.

The my address search is described further for a case where the login name is used as the keyword.

First, a keyword is set (step S901). That is, a login name of a user who is a current login user of the multifunction peripheral is employed as the keyword. Next, a search is executed (step S902). In this search, all login names each including as a part the keyword set in the previous step are searched for. For example, in a case where the keyword is “userA”, records having login names each including as a part “userA” are searched for. In the present example, as shown in FIG. 8C, four records respectively including, in their login name fields, “userA”, “userA_home”, “userA_emergency”, and “userA_additional” are detected.

In the my address search screen shown in FIG. 8C, the login name set as the keyword is displayed in a textbox SP3, and the login names of the records detected in the search are displayed in a list L1 as shown in FIG. 8C (step S903).

The series of processes from step S901 to step S903 described above is automatically performed when the my address search button 132 is pressed.

FIG. 8C illustrates an example of the search result. In this example, the search is performed using, as the keyword, the login name “userA” of the user who is a current login user of the multifunction peripheral, and detected login names are displayed as the search result, that is, “userA”, “userA_home”, “userA_emergency”, and “userA_additional” each including “userA” as a part are displayed.

If the user selects one of the displayed addresses (in a case where it is determined YES in step S904), the address selected as the transmission destination from the list of the search result is stored in a temporary storage unit (step S905). This selection is performed when the user touches an address to be selected with his/her finger P on the touch panel screen shown in FIG. 8C. In the example shown in FIG. 8C, “userA” is selected, and thus a check mark C is displayed. As with the selection from the address book, it is also allowed to select a plurality of destination addresses from the search result.

If the “OK” button B6 is pressed in this situation (if the determination in step S906 is YES), the destination address selected in step S904 is stored. In a case where no destination address is selected, NULL is stored (step S907). In the example shown in FIG. 8C, “userA, suzuki@example.com” is stored.

In a case where it is determined that the textbox SP3 is pressed (YES in step S908), the process proceeds to a keyword edit routine (step S909).

In a case where it is determined that a search-again button P7 is pressed (YES in step S910), the process returns to step S902 to again perform the process of the search.

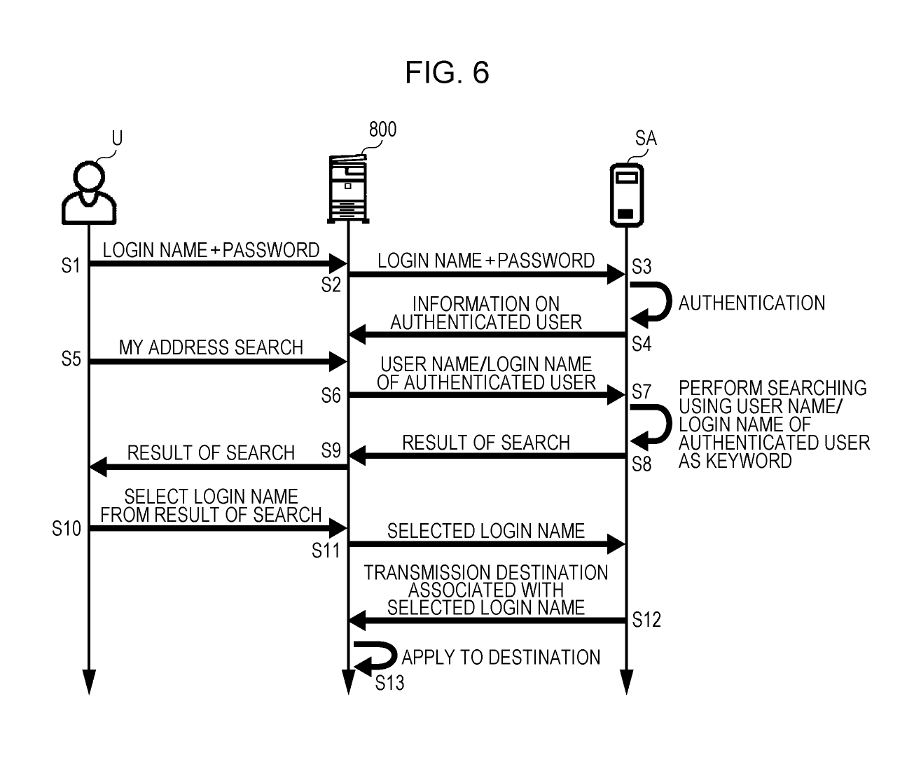

Next, referring to FIG. 6, the processing flow of the my address search (step S900) shown in FIG. 3 is described in further detail below.

A user U inputs a login name and a password to the multifunction peripheral 800 (step S1). The authentication screen displayed on the display unit 852 in this situation includes, as illustrated in FIG. 5A, a textbox SP1 for inputting the “login name”, a textbox SP2 for inputting the “password”, and the authentication button B1 used by the user U to issue an authentication request to the external authentication server SA. The multifunction peripheral 800 transmits the input login name and password to the external authentication server SA (step S2). The external authentication server SA1 performs authentication by comparing the input login name and password with the registered login name and password (step S3), and the external authentication server SA transmits information relating to the authentication of the user to the multifunction peripheral 800 (step S4).

Next, when the multifunction peripheral 800 accepts a request of “my address search” from the user U (step S5), the multifunction peripheral 800 transfers this request to the external authentication server SA (step S6). The request for the “my address search” is issued when the user U presses one of the my address search buttons B2, B3, and B4 respectively displayed on the scanner screen, the address book screen, and the home screen respectively shown in FIG. 7A, FIG. 7B, and FIG. 7C.

The external authentication server SA uses, as the keyword, the login name of the user authenticated by the external authentication server SA (step S7). As shown in FIG. 8C, the keyword of “userA” is displayed in the textbox SP3. The external authentication server SA transmits a search result to the multifunction peripheral 800 (step S8). The multifunction peripheral 800 displays the search result received from the external authentication server SA on the display unit 852 of the operation panel 850 (step S9). For example, in a case where the input login name is “userA” as shown in FIG. 5A, login names each including “userA” as a part thereof are searched for and all detected login names are displayed as shown in FIG. 8C.

In FIG. 8C, “userA”, “userA_home”, “userA_emergency”, and “userA_additional” are displayed as the login names obtained as a result of the search. Note that the login name “userA” shown in FIG. 8C is editable by the user. For example, if “Emergency” is added to “userA” so as to obtains “userA_Emeregency”, then, from the beginning, the search is narrowed to those including “userA_Emeregency” in the user name.

Note that, the email addresses described above are merely examples, and other various email addresses specified by the user may be actually used.

The user may select a login name associated with an email address to which scanned data is to be transmitted by touching the login name displayed on the touch panel screen with his/her finger P (step S10). A check mark C is displayed so as to indicate that the login name is selected by the user. The multifunction peripheral 800 transmits information relating to the login name selected by the user to the external authentication server SA (step S11). The external authentication server SA transmits the email address associated with the login name received from the multifunction peripheral 800 to the multifunction peripheral 800 (step S12).

As shown in FIG. 9, the multifunction peripheral 800 sets the email address received from the external authentication server SA as the destination address (step S13). An email address “suzuki@example.com” associated with the login name “userA” selected in FIG. 8C is displayed in a destination address text box SP4 shown in FIG. 9.

On this screen, if a start button B8 is pressed with a finger P, the control unit 50 executes a job. That is, for example, scanned data output from a scanner is transmitted to the specified email address “suzuki@example.com” via the interface 870.

A my address search button may be provided as a shortcut key on a home screen. This makes it possible to immediately execute the my address search, which results in an improvement in usability.

In the present embodiment, records to be searched for in the my address search are described in the user list table 653. Alternatively, a table dedicated for use in the my address search may be prepared, and records to be searched for in the my address search are described in this dedicated table. This makes it unnecessary to describe records, which are used only in the my address search but not used in usual login, in the user list table 653.

As described above, by simply pressing the “my address search” button and selecting a desired transmission destination including as a part the login name of the user, the user is allowed to specify, as the destination address, the email address related to the user and associated with the selected transmission destination. Thus, it is possible to quickly and simply specify an email address to which scanned data is to be transmitted.

Furthermore, the authentication information including the login name and the password and the corresponding transmission destination indicated by the user name or the email address or the like are registered in the external authentication server SA and the authentication and the my address search are performed by the external authentication server SA, and thus it is possible to perform registration and maintenance of information using only the external authentication server SA. In particular, in a case where a plurality of multifunction peripherals are used, it is ensured that consistency of data among the plurality of multifunction peripherals is achieved and extremely high efficiency is achieved, and thus a greater advantage is provided than is achieved in a case where information is registered separately in each multifunction peripheral and authentication is performed separately.

### Second Embodiment

Next, an information transmission apparatus according to a second embodiment of the disclosure is described below.

In this second embodiment, the external authentication server SA shown in FIG. 1 is replaced with an LDAP/AD (Lightweight Directory Access Protocol/Active Directory) server SA. The ADAP/AD server SA has functions similar to those of the external authentication server SA.

The LDAP/AD server is a server using a protocol for accessing an active directory service and provides a service of performing a search using a user name or the like as a keyword to find an email address associated with the user name or other information and providing information detected in the search to a client.

A description of LDAP may be found, for example, at a web site “https://msdn.microsoft.com/ja-jp/library/cc419640.aspx”, and a description of AD may be found, for example, at a web site “https://technet.microsoft.com/jajp/windowsserver/bb466131.aspx”.

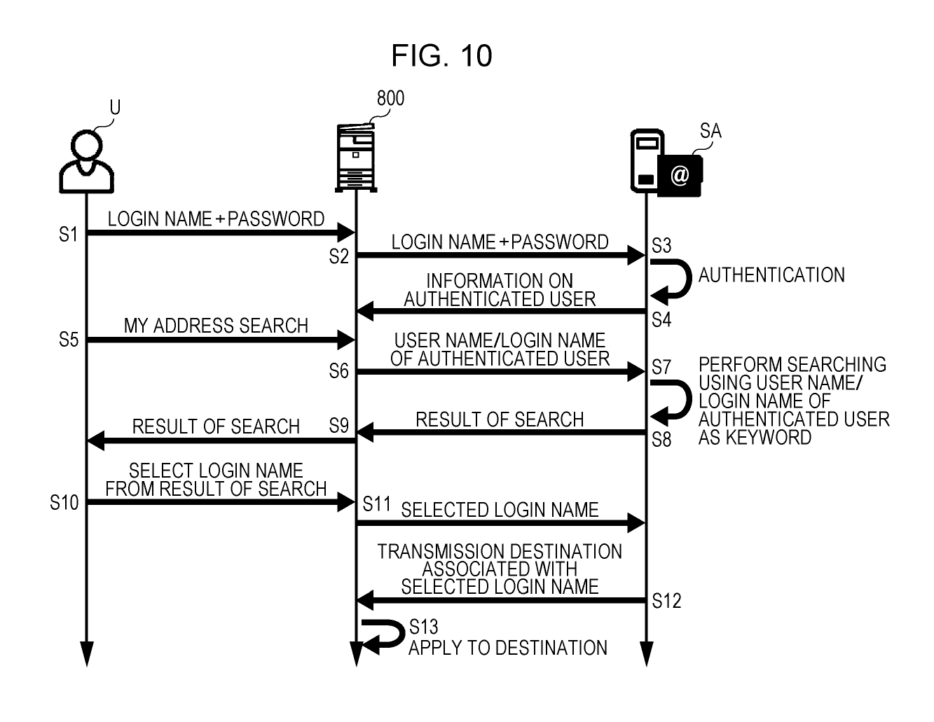

FIG. 10 is a sequence diagram illustrating an operation performed in the my address search according to the second embodiment. As may be seen from a comparison with FIG. 6 illustrating the operation performed in the my address search according to the first embodiment, the only difference is in that the apparatus that operates for the multifunction peripheral 800 is changed from the external authentication server SA to the LDAP/AD serve. Therefore, in the description given above with reference to FIG. 6, if the external authentication server SA is read as the LDAP/AD server, then a description of the sequence of the operation in the my address search according to the second embodiment is obtained, and thus a further description thereof is omitted.

### Third Embodiment

When the “my address search button” is pressed, searching may be performed in a preset search mode search, suffix search, or partial match) using a login name as a keyword, and a search result may be directly displayed on the my address screen. In this case, the login name may be displayed in the textbox SP3 of the my address screen.

Alternatively, when the “my address search button” is pressed, the login name may be displayed in the textbox SP3 of the my address screen before the search is started. If the search button is pressed in this state, the search may be performed. This makes it possible for the user to confirm the login name before the search is performed.

In any case, the search condition may be changed and the search may be performed using the changed search condition, or the login name displayed as the keyword in the textbox SP3 may be edited using a soft keyboard or the like and then the search may be performed, or after these two things are performed, the search may be performed.

For example, in a case where there are many login names in each of which a particular text string varying depending on its purpose is added to a fixed primary part, the search may be performed after making an edition to add a particular text string to the fixed primary part of the login name. This makes it possible to narrow the search result in advance.

### Fourth Embodiment

The first embodiment has been described above for a case where searching is performed using a login name as a keyword, and transmission is addressed to an email address associated with the login name detected as a result of the searching. Alternatively, a user name associated with a login name may be used as a keyword, or a combination of a login name and a user name may be used as a keyword.

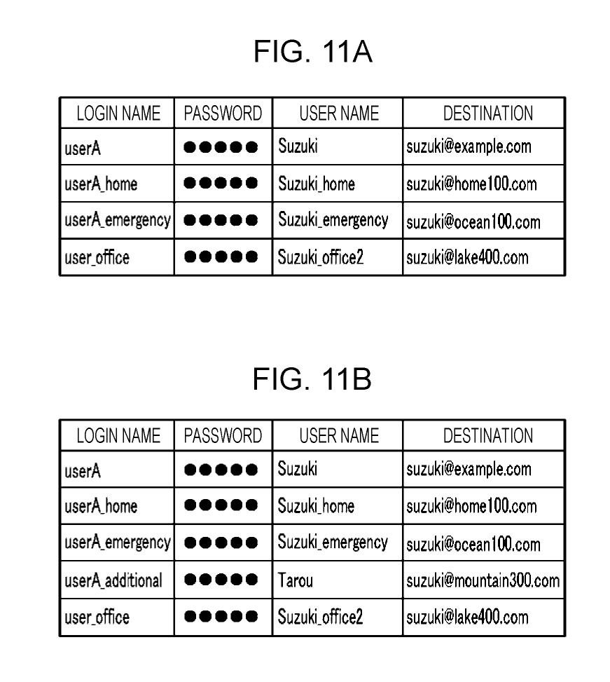

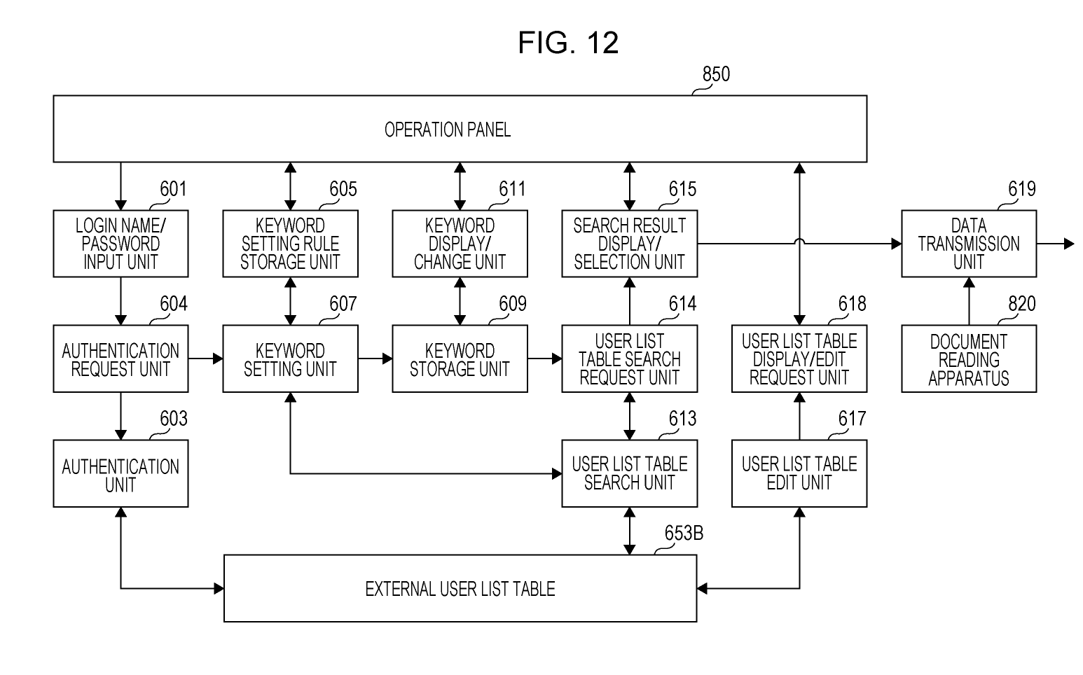

FIG. 11A illustrates an example of a search result obtained when a user name is used as a keyword. In this example, a user name “Suzuki” is used as a keyword. The search result is displayed as a list L1 shown in FIG. 8C such that a user is allowed to make a selection from the list L1.

FIG. 11B shows a search result obtained for a case where a combination of a login name and a user name is used as a keyword, and more specifically, in this example, a combination of a login name “userA” and a user name “Suzuki” is used as the keyword. The search result is displayed as a list L1 shown in FIG. 8C such that a user is allowed to make a selection from the list L1.

### Fifth Embodiment

In the embodiments described above, the transmission destination is specified by an email address. Alternatively, the destination may be specified by a global IP address or a private IP address. In this case, scanned data output from the scanner may be transmitted to particular hardware using FTP or the like.

### Sixth Embodiment

In the embodiments described above, it is assumed by way of example that scanned data output from the scanner is transmitted to a specified email address. Alternatively, received facsimile data obtained via the transmission/reception unit 860 or various kinds of data received via the interface 870 may be transmitted to a specified email address.

### Seventh Embodiment

In previous embodiments, various search conditions such as prefix search, suffix search, or partial match may be specified in the search. In this case, for example, when the login name is “userA”, the search in the prefix search mode may provide, as a search result, “userA_home”, “userA_emergency”, “userA_additional” and/or the like. For example, when the login name is “userA”, the search in the suffix search mode may provide, as a search result, “home_userA”, “emergency_userA”, and/or the like. Furthermore, for example, when the login name is “userA”, the search in the partial match mode may provide, as a search result, “home_userA_sample”, “emergency_userA_sample”, and/or the like.

### Eighth Embodiment

In the embodiments described above, a stop button or the like may be provided such that when the stop button is pressed in the middle of the my address search, the search may be stopped. This results in an improvement in usability.

### Ninth Embodiment

In the embodiments described above, in a case where a login name, a user name, or the like is hit in the my address search, if no email address is associated with this login name or user name, then the login name may not be displayed in the search result. Removing useless information from the displayed search result makes it possible to achieve an improvement in usability.

### Tenth Embodiment

In the embodiments described above, in either case where a login name or a user name is used as a keyword, not only the login name hit in the search but also an associated email address may be displayed. This makes it possible to confirm the email address, and thus it becomes possible to reduce the probability of wrong selection.

### Eleventh Embodiment

In the previous embodiments, a usage restriction may be set for each transmission destination. In a case where a search result includes a transmission destination which is restricted in use, the transmission destination may be set unselectable. This ensures that data is not transmitted to a wrong destination address, and thus an improvement in usability is achieved.

### Twelfth Embodiment

In previous embodiments, a usage may be limited such that a user whose user information includes no transmission destination information is not allowed to use the functions described above in the embodiments. This results in a reduction in security risk.

### Thirteenth Embodiment

A manager may set a usage individually for each login name as to whether the functions of the embodiments described above are allowed to be used or not.

### Fourteenth Embodiment

Each entry including at least a login name and an email address associated with each other is stored in an address book table. The address book table may be a usual-use address book table in which usual-use transmission addresses are described, or may be an address book for use in the my address search according to one the embodiments provided separately from the usual-use address book table. In either case, the address book table may be prepared for each user such that the address book table corresponds to a login name of the user. However, an address book table may be shared by a plurality of users if operation is possible such that no confusion or the like occurs among the plurality of users. For example, in a case where a name of a section or the like of a company or the like is used as a login name, the my address search function may be used on a section-by-section basis. In the case where a section name is used as a login name, it is not excluded that each individual makes a login using a login name of the individual. Each individual is allowed to use the my address search function for a personal use depending on a purpose, or each individual is allowed to use the my address search function as a member of the section.

### Fifteenth Embodiment

The authentication information may or may not be a text string representing a login name. For example, the authentication information may be biometric authentication information in terms of a fingerprint, a palm print, an iris, or the like. In this case, a login name represented by a text string may be associated with biometric authentication information in an authentication server or a particular functional unit (for example, an authentication unit) of the multifunction peripheral 800. When a user logs in using biometric authentication information, a login name or a user name associated with the biometric authentication information or a text string obtained by editing the login name or the user name may be used as a keyword in the functions of the previous embodiments.

### Sixteenth Embodiment

Index information related to the authentication information may be automatically generated. For example, when additional transmission destinations for a user having a login name “userA” are registered, records respectively including userA1, userA2, and/or the like as login names may be automatically added to the user list table. The user may be allowed to further add user names and email addresses as transmission destinations to these records. For example, for preparation to allow a user having a user name Suzuki to register additional transmission destinations, records respectively including SuzukiA1, SuzukiA2, and/or the like as login names may be automatically added to the user list table. The user may be allowed to further add login names and email addresses as transmission destinations to these records.

### Seventeen Embodiment

Next, referring to FIG. 23, a seventeenth embodiment is described. In this embodiment, a my address search apparatus includes a keyword setting rule storage unit 605, a keyword setting unit 607, a keyword storage unit 609, a keyword display/change unit 611, a user list table search unit 613, a user list table search request unit 614, a search result display/selection unit 615, a user list table edit unit 617, and a user list table display/edit request unit 618.

An external user list table 653B, a login name/password input unit 601, an authentication unit 603, an authentication request unit 604, a data transmission unit 619, a document reading apparatus 820, and an operation panel 850 are units that are used by the my address search apparatus, and these may be included in the my address search apparatus.

The keyword setting rule storage unit 605, the keyword setting unit 607, the keyword storage unit 609, the keyword display/change unit 611, the user list table search request unit 614, the search result display/selection unit 615, the user list table display/edit request unit 618, the login name/password input unit 601, the authentication request unit 604, the data transmission unit 619, the document reading apparatus 820, and the operation panel 850 are included in the multifunction peripheral 800, while the authentication unit 603, the user list table search unit 613, the user list table edit unit 617, and the external user list table 653B are included in the external authentication server SA.

The external user list table 653B stores, for each user, a set of a login name, a password, a user name, and an email address. The external user list table 653B also stores a set of a login name, a password, a user name, and an email address to be searched for in the my address search. A login name used by a user when a login is made by the user is employed as a keyword, while other login names each including as a part this login name function as labels. The login name used by the user when a login is made by the user is also included in the search result, and thus this login name functions as one of the labels. A user name corresponding to the login name used by the user when the login is made by the user may also be used as a keyword in the my address search. In this case, other user names each including as a part this user name function as labels. The user name corresponding to the login name used by the user when the login is made by the user is also included in the search result, and thus this user name functions as one of the labels.

The login name/password input unit 601 inputs a login name and a password in response to an operation performed by a user on the operation panel 650.

In response to a request from the authentication request unit 604, the authentication unit 603 performs authentication determining whether the set of the login name and the password input via the login name/password input unit 601 is identical to any set of a login name and a password stored in the external user list table 653B. If an identical set is found, the authentication unit 603 determines that the user authentication is passed successfully.

The keyword setting rule storage unit 605 accepts keyword specification information, input by a manager, a user, or the like via the operation panel 850, as to whether a login name, a user name, or both are used as a keyword in the my address search, and the keyword setting rule storage unit 605 stores the keyword specification information.

The keyword setting unit 607 sets a keyword according to the keyword specification information stored in the keyword setting rule storage unit 605. In a case where use of login name as a keyword is specified, a login name of a login user is set as the keyword. In a case where use of user name as a keyword is specified, a user name corresponding to a login name of a login user is set, as the keyword. In a case where use of a combination of a login name and a user name as the keyword is specified, a combination of a login name of a login user and a corresponding user name is set as the keyword. Note that a user name used as a keyword may be acquired from the external user list table 653B by performing searching using a login name as a keyword by using the user list table search unit 613.

The keyword set by the keyword setting unit 607 is stored in the keyword storage unit 609 together with an attribute indicating either a corresponding login name or user name.

The keyword display/change unit 611 displays the keyword stored in the keyword storage unit 609 in an editable textbox provided on the operation panel 850. When an operation of changing the keyword is performed on the operation panel 850, the keyword display/change unit 611 accordingly changes the keyword stored in the keyword storage unit 609.

The user list table edit unit 617 and the user list table display/edit request unit 618 cooperate to display the content of the external user list table 653B via the operation panel 850 and accept an operation to add, change, or delete a user to/in/from the external user list table 653B. In particular, the adding is performed for a user who is to be searched for in the my address search. That is, the adding is performed for a user having a login name including as a part a usual-use login name. The adding may be performed for a user having a user name corresponding to a usual-use login name. Furthermore, the adding may be performed for a user having a login name including as a part a text string obtained as a result of editing a usual-use login name of the user. The adding may be performed for a user having a user name including as a part a text string obtained as a result of editing a user name corresponding to a usual-use login name. The allowable degree to which the original login name or the user name is edited may be determined by a user or may be determined in advance.

The user list table search request unit 614 and the user list table search unit 613 cooperate to search the external user list table 653B using the keyword stored in the keyword storage unit 609. That is, in a case where the login name is specified as the keyword, records having a login name which is prefix-matched, suffix-matched, or partially-matched to the keyword are extracted from the external user list table 653B, and login names, user names, and transmission destinations (email addresses or the like) described in the extracted records are output as a search result. In a case where the user name is specified as the keyword, records having a user name which is prefix-matched, suffix-matched, or partially-matched to the keyword are extracted from the external user list table 653B, and login names, user names, and transmission destinations described in the extracted records are output as a search result. The search condition as to whether the search is to be performed in prefix, suffix, or partial matching mode is specified via a unit not shown in the figure. In initial setting, use of login name as the keyword may be specified. In this case, the login name may be directly used as the keyword unless otherwise specified. Alternatively, in the initial setting, use of user name as the keyword may be specified. In this case, the user name may be directly used as the keyword unless otherwise specified. Alternatively, in the initial setting, use of a combination of a login name and a user name as the keyword may be specified. In this case, the combination of the login name and the user name may be used as the keyword unless otherwise specified.

URL, an IP address, and a facsimile number may be added to the external user list table, and URL, the IP address, or the facsimile number in addition to an email address may be selected as the transmission destination.

The search result display/selection unit 615 displays, on the operation panel 850, a list of search results performed by the user list table search request unit 614 and the user list table search unit 613. The displayed list includes detected login names, user names, and email addresses employable as a transmission destination. When a transmission destination in the list is specified, the specified transmission destination is set as the transmission destination.

### Eighteenth Embodiment

The user list table edit unit 617 and the user list table display/edit request unit 618 cooperate to display names, email addresses, URLs, IP addresses, and/or the like of communication partners stored in the external user list table 653B and edit them. The editing includes adding, changing, and deleting. In particular, my addresses to be searched for in the my address search function may be displayed as communication partners and may be edited.

Furthermore, the user list table edit unit 617 and the user list table display/edit request unit 618 may cooperate to make setting such that using the authentication unit 603 and the external user list table 653B, a login name and a user name of a user who is a current login user are set as initial values associated with a destination to be registered in the address book. This makes it possible for a user to easily edit the my address to be searched for in the my address search function simply by adding a desired text string, a numeral, or a symbol or a combination thereof to the initial value.

The information transmission apparatus described above may be realized using hardware or software or combination of hardware and software. The information transmission method executed by the information transmission apparatus may also be realized using hardware or software or combination of hardware and software. More specifically, to realize the information transmission apparatus or the information transmission method, a program may be read by a computer and executed.

The program may be stored in a non-transitory computer readable medium of any of various types and may be supplied to the computer via such a medium. The non-transitory computer readable media include various types of tangible storage media. Examples of non-transitory computer readable media include a magnetic storage medium (such as a flexible disk, a magnetic tape, a hard disk drive), a magneto-optical storage medium (such as a magneto-optical disk), a CD-ROM (Read Only Memory) disk, a CD-R disk, a CD-R/W disk, a semiconductor memory (such as a mask ROM or a PROM (Programmable ROM), an EPROM (Erasable ROM), a flash ROM, a RAM (Random Access Memory), and the like. The program may be supplied to the computer via a transitory computer readable medium of one of many types. Note that an electric signal, an optical signal, and an electromagnetic wave are examples of transitory computer readable media. A transitory computer readable medium may supply the program to the computer via a wired communication line such as an electric wire, an optical fiber, or the like or a wireless communication line.

The invention may be embodied in other specific forms without departing from the spirit or essential characteristics thereof. The embodiments described above are therefore to be considered in all respects as illustrative and not restrictive. The scope of the disclosure is indicated by the appended claims rather than by the foregoing description, and all changes which come within the meaning and range of equivalency of the claims are therefore intended to be embraced therein.

The present disclosure is usable to select a destination address to which information is to be transmitted from an address associated with a user authenticated by a server or an address related to the user.

The present disclosure contains subject matter related to that disclosed in Japanese Priority Patent Application JP 2017-162940 filed in the Japan Patent Office on Aug. 28, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information transmission apparatus comprising:
a unit configured to cause an authentication unit to perform authentication based on authentication information;
a unit configured to cause a search unit to search for at least one transmission destination associated with the authentication information by using a text string corresponding to the authentication information as a keyword; and
an information transmission unit configured to transmit information using a result of the search performed by the search unit,
wherein the authentication unit and the search unit are disposed in an external apparatus connected to the information transmission apparatus via a network.

2. The information transmission apparatus according to claim 1, wherein the authentication unit and the search unit refer to a common database.

3. The information transmission apparatus according to claim 1, wherein the text string corresponding to the authentication information used as the keyword is a login name corresponding to the authentication information or a user name associated with the authentication information or both.

4. The information transmission apparatus according to claim 3, wherein
the login name corresponding to the authentication information and the user name associated with the authentication information are editable, and
wherein in a case where the login name corresponding to the authentication information or the user name associated with the authentication information is edited, the resultant edited login name or user name is used as the keyword instead of the unedited login name or user name.

5. The information transmission apparatus according to claim 1, wherein the search unit searches for at least one transmission destination associated with the authentication information by performing a prefix search, a suffix search, or a partial search for the keyword.

6. The information transmission apparatus according to claim 1, wherein the search unit employs as a search target a table including one or more sets each including a login name, a user name, and a transmission destination, and performs the search by comparing the keyword with the login name or the user name.

7. The information transmission apparatus according to claim 6, further comprising a unit configured to generate an additional login name or user name based on an existing login name or user name and add a record including at least the generated login name or user name to a table employed as a search target.

8. The information transmission apparatus according to claim 6, wherein the table includes one or more records each including a login name or a user name, the login name or the user name including at least a part of a text string corresponding to the authentication information.

9. The information transmission apparatus according to claim 1, further comprising a setting unit configured to set, as a transmission destination of information, a transmission destination selected from a result of the search performed by the search unit.

10. The information transmission apparatus according to claim 9, further comprising a selection unit configured to select a transmission destination from a result of the search performed by the search unit.

11. The information transmission apparatus according to claim 9, further comprising a transmission destination addition unit configured to add another transmission destination to transmission destinations set by the setting unit.

12. A multifunction peripheral comprising the information transmission apparatus according to claim 1.

13. An information transmission system comprising:
an authentication unit configured to perform authentication based on authentication information; a search unit configured to search for at least one transmission destination associated with the authentication information by using a text string corresponding to the authentication information as a keyword; and
an information transmission unit configured to transmit information using a result of the search performed by the search unit,
wherein the authentication unit and the search unit are disposed in an external apparatus connected to an apparatus including the information transmission unit via a network.

14. An information transmission method comprising:
performing authentication based on authentication information;
searching for at least one transmission destination associated with the authentication information by using a text string corresponding to the authentication information as a keyword;
transmitting information using a result of the search performed in the searching,
wherein the authentication and the search are performed in an external apparatus connected via a network to an apparatus that performs the transmission of the information.

15. An information transmission program for causing a computer to function as the information transmission apparatus according to claim 1.
